(19) United States
(12) Patent Application Publication
(10) Pub. No.: US 2022/0150440 A1
(43) Pub. Date: May 12, 2022

(54) METHOD FOR SCANNING TELEVISION CHANNELS AND TELEVISION SYSTEM

(71) Applicant: REALTEK SEMICONDUCTOR CORP., HSINCHU (TW)

(72) Inventor: FEI LU, Suzhou (CN)

(21) Appl. No.: 17/454,239

(22) Filed: Nov. 9, 2021

(30) Foreign Application Priority Data
Nov. 11, 2020 (CN) 202011253053.6

(51) Int. Cl. H04N 5/50; H04N 21/438

(52) U.S. Cl. CPC H04N 5/505; H04N 21/4384; H04N 21/4382

(57) ABSTRACT

A method for scanning television channels and a television system are provided. The television system includes a circuit system, a storage unit, and a control circuit. The circuit system is used to receive and demodulate television streaming data, separate information in the television streaming data, and decompress and convert the television streaming data into video and audio. The method is performed in the control circuit. In the method, a channel-selection transceiver circuit receives a channel-selection signal. After channel data stored in the storage unit is analyzed, it is determined whether the channel-selection signal corresponds to any television channel in the channel data. If the channel data does not include the television channel corresponding to the channel-selection signal, a scanning routine is performed in a background for scanning the television channels. A scanning result is then generated and used to update the channel data in the storage unit.

### CROSS-REFERENCE TO RELATED PATENT APPLICATION

This application claims the benefit of priority to China Patent Application No. 202011253053.6, filed on Nov. 11, 2020, in People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for scanning television channels, and more particularly to a method for solving a problem of the television channels being scanned incompletely and a television system.

### BACKGROUND OF THE DISCLOSURE

Whether for digital television channels or analog channels, a procedure of scanning television channels needs to be performed before television programs can be watched. For example, a television device is turned on after an antenna thereof is set, and the procedure of scanning the television channels is performed through switching to a digital television program menu or analog television program menu by use of a remote control. In the meantime, a scanning program executed in the television device is used to scan the television channels by switching the channels continuously. The scanning program then records information such as a channel name, a channel ID or any description thereof with respect to each of the television channels that are scanned successfully.

When the television channels are recorded in the television device, a user relies on the channel IDs to switch to one of the television channels by the remote control. However, in the stage of scanning the television channels, an error may occur to the television channel to be selected if the scanning program fails to scan the television channels due to weak signals or a void channel.

The television channels may need to be scanned again when failing to correctly switch to a specific television channel.

### SUMMARY OF THE DISCLOSURE

In a conventional television system, after television channel data is received, some problems may occur to the television system. For example, the television system may get void channels due to incomplete television channel scanning. Errors may occur in the system when the television channel scanning is improperly interrupted, or television channels cannot be scanned immediately if the system provides a wrong channel. In view of the above-mentioned disadvantages of the conventional technologies, provided in the present disclosure is a method for scanning television channels and a television system. In the method, a scanning routine executed in a background is used to scan the television channels that fail to correspond to any content, and then a user can quickly access the television channel data that originally failed to contain any content.

In the method for scanning television channels, when the user manipulates a remote control to generate a channel-selection signal, the scanning routine executed in the television system determines whether or not the channel data stored in the system corresponds to a television channel selected by the user after analyzing the channel data stored in a television apparatus. If the channel data includes the data of the television channel selected by the user, the television system switches to said television channel. On the other hand, if the channel data fails to correspond to the content corresponding to the selected television channel, the scanning routine is performed in the background for scanning the television channels that fail to correspond to the channel-selection signal. A scanning result is provided and used to update the channel data stored in the television apparatus.

According to one embodiment, main circuits of the television system includes a circuit system that is used to receive television streaming data, demodulate the television streaming data and separate information in the television streaming data. The television streaming data is then decompressed and converted to video and audio. The television system includes a storage unit that includes a channel database. The system also includes a control circuit that is used to perform the method for scanning television channels.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram depicting a circumstance in which a user uses a remote control to switch television channels;

FIG. 2 shows a flow chart describing a process of obtaining channel data and playing a program of a selected channel according to one embodiment of the present disclosure;

FIG. 3 is a block diagram depicting function modules of a television system according to one embodiment of the present disclosure; and

FIG. 4 shows a flow chart describing a method for scanning television channels according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

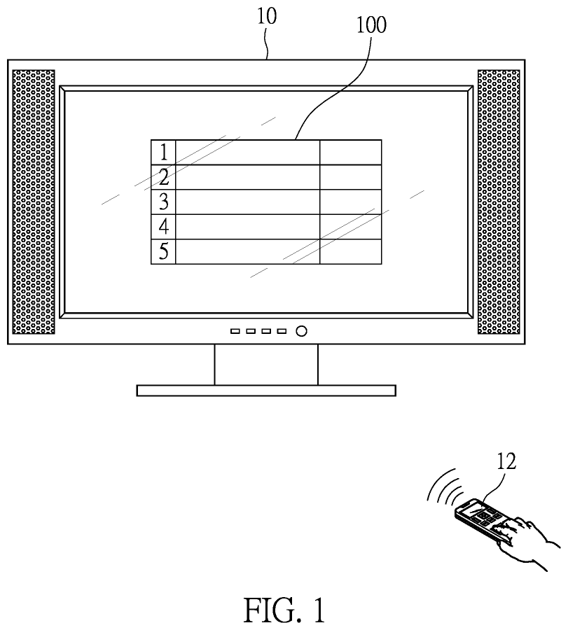

The present disclosure is related to a method for scanning television channels and a television system, which are adapted for a circumstance exemplarily depicted in a schematic diagram of FIG. 1 where a user selects one of the channels.

In the diagram, the user manipulates a remote control 12 toward a television apparatus 10 to select one of the television channels. In one aspect of the present disclosure, a television program guide 100 shown on a screen of the television apparatus 10 is formed according to channel data stored in a storage device of the television apparatus 10. The user relies on the television program guide 100 to make a selection of the channels.

In general, the user can use the remote control 12 to generate a channel-selection signal. A channel ID can be obtained after a circuit system of the television apparatus 10 analyzes the channel-selection signal. Afterwards, the circuit system searches a corresponding television channel from the channel data stored in the storage device of the television apparatus 10 and provides channel information to the user. In the meantime, real-time television streaming data can be loaded to the television apparatus 10 from an external content server. The television streaming data can be digital television data, analog television data or other digital content provided by a specific A/V service platform. It is worth noting that, in a process for scanning the television channels, a sequence can be applied to the digital television data and the analog television data. For example, the process for scanning the digital television channels can be prioritized, such that the digital television channels can be scanned at anytime in a background, and then the analog television channels are scanned.

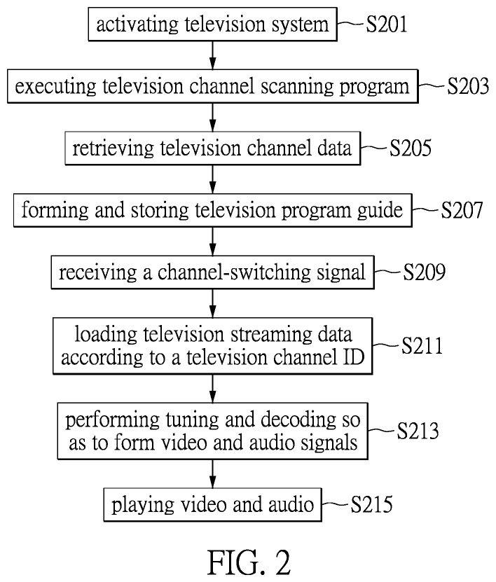

The above-mentioned operations can be referred to in FIG. 2, which shows a flow chart describing a process for obtaining channel data and playing content according to the selection of the user.

In the beginning, the user sets up a television apparatus via a conventional scanning routine to scan the channels. A scanning result including channel IDs and content is stored in the television apparatus for the user to select one of the channels. In step S201, a television system operating the television apparatus is initiated, i.e., turning on power of the television apparatus. In the meantime, in step S203, a function for scanning the television channels in a function menu is selected, and a scanning program is performed to scan the television channels. The scanning program operates a scanning routine that can continuously switch the channels covered by a television antenna. In step S205, television channel data for each of the channels can be obtained. The channel data is stored to a storage device of the television apparatus. The television channel data includes television channel IDs, names, content and television programs of the television channels. In step S207, an electronic program guide (EPG) is formed and stored to the storage device.

After all the television channels are scanned, the user can use a remote control or a control interface of the television apparatus to select one of the channels. In step S209, a channel-switching signal is generated in the television system. A channel-selection signal is then received by the television system in step S211. Through connection to an external server, the television streaming data is loaded according to a television channel ID corresponding to the channel-selection signal. In step S213, the television system performs tuning and decoding upon the streaming data, so as to render video and audio signals. Next, in step S215, the content is played by the television apparatus.

The scanning program performed in the television system is used to scan television channels. However, scanning of the television channels may be incomplete due to failure of the television signals. One or more void channels may be generated, and the scanning program should be performed again. It should be noted that the scanning process cannot be interrupted; otherwise, an error will occur and a new void channel is generated.

In the method for scanning television channels and the television system provided by the present disclosure, the television system performs the method for scanning the television channels that cannot correspond to any content through a background scanning routine. Under a circumstance that the user is not aware of the void channels, the method allows the television system to quickly update the television channel data that corresponds to no data in the previous scanning process.

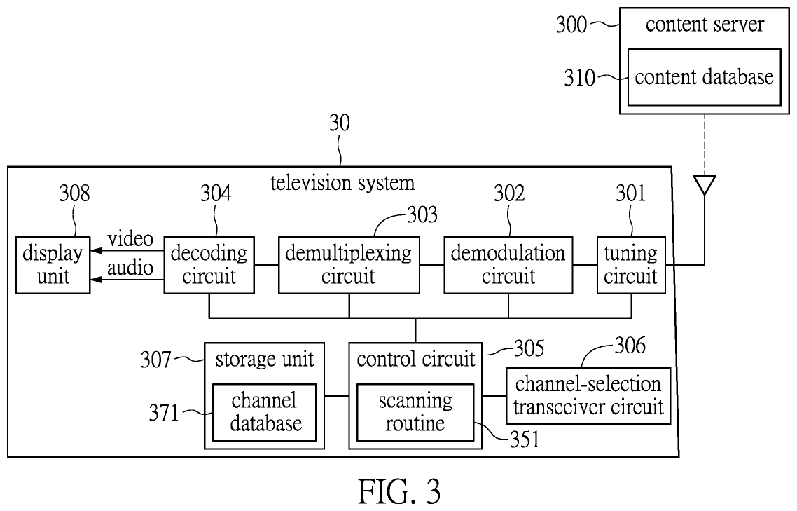

A circuit in the television system that is used to implement the method for scanning television channels is referred to in FIG. 3, which is a schematic diagram depicting the circuit according to one embodiment of the present disclosure.

The circuit system of the television system 30 is mainly used to receive the television streaming data, demodulate the television streaming data and separate information therein. The television streaming data is then decompressed and converted into video and audio. The circuit system includes a storage unit 307 having a channel database 371. The channel database 371 is configured to store the channel data that has been demodulated, demultiplexed and decompressed.

One of the main circuit elements of the circuit system is a tuning circuit 301. The tuning circuit 301 is used to receive the television streaming data. With wireless television signals as an example, a digital television tuner, i.e., the tuning circuit 301, receives the signals, performs filtering, amplifies radio-frequency signals, performs frequency reduction, and performs analog-to-digital conversion. Afterwards, a demodulation circuit 302 demodulates the television streaming data that has been processed by the digital television tuner, so as to form television signals compatible to the circuit system. A demultiplexing circuit 303 performs demultiplexing for separating information in the television streaming data. A decoding circuit 304 then decodes the television streaming data and converts the television streaming data into video and audio signals. The video and audio signals are played by a display unit 308.

When the television system 30 is in operation, a channel-selection signal is generated via a remote control or a control interface initiated in the television apparatus. A control circuit 305 electrically connected to the circuit elements in the circuit system performs the method for scanning television channels via a scanning routine 351, so as to deal with problems of void frequency occurring after the user has made the selection.

The television system 30 includes a channel-selection transceiver circuit 306 that can be a circuit used to process infrared signals or specific wireless communication signals. The channel-selection transceiver circuit 306 is used to receive a channel-selection signal generated by the remote control manipulated by the user. The channel-selection signal is then converted to a signal provided for the control circuit 305 to acquire the corresponding channel data.

In an exemplary example, a digital television system is connected to a content server 300 that includes a content database 310 used to store various television information and contents provided by channel operators. The content server 300 allows the television system 30 to receive the channel data downloaded from the content server 300 in a streaming mode. Before the method for scanning television channels is performed, via the scanning routine 351, the television system 30 can acquire the channel data including one or more television channel data received from the content server 300. The channel data is then stored to the channel database 371 in the storage unit 307.

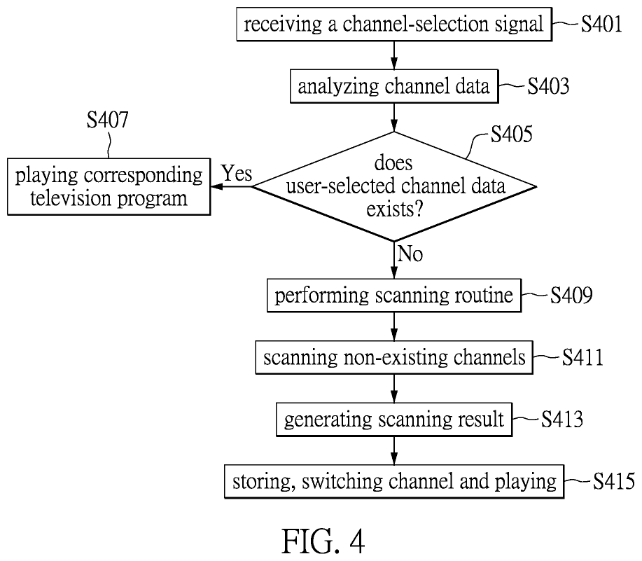

After that, referring to a flow chart shown in FIG. 4, the television system 30 performs the method for scanning television channels according to one embodiment of the present disclosure.

The user manipulates the remote control or the control interface of the television apparatus to generate the channel-selection signal. The television system 30 receives the channel-selection signal corresponding to a television channel via the channel-selection transceiver circuit 306 (step S401). The control circuit 305 analyzes the channel data stored in the storage unit 307 (step S403) and determines whether or not the channel data includes the data of the television channel corresponding to the channel-selection signal (step S405). If the channel data includes the television channel data, such as in step S407, the television apparatus plays the television program corresponding to the channel ID in response to the channel-selection signal; otherwise, the scanning routine 351 is performed in a background since the television channel data corresponding to the channel-selection signal does not exist in the channel data (step S409). The scanning routine 351 in the method is configured to scan the television channels that fail to correspond to the channel-selection signals (step S411). A scanning result is generated (step S413). The scanning result is provided for the television system to update the channel data stored in the storage unit. In the subsequent process, the television system 30 can receive the scanning result obtained by the scanning routine via a channel-switching routine and then switch to the television channel corresponding to the channel-selection signal. The television system 30 then plays the content according to the television channel selected by the user (step S415).

It should be noted that the scanning routine runs in the background without disturbing the user who is watching television. The scanning routine can be activated at any time or when the system detects any void channel, and can be used to acquire the channel data that corresponds to no data in the previous scanning process. After that, the television system continues to load the television streaming data according to the television channel selected by the user.

Moreover, the scanning routine can be used as a routine for creating initial channel data for the television system, or another proprietary routine can create the initial channel data. When the scanning result is generated by the background scanning routine, the scanning result can be used to update the channel data stored in the storage unit, and can also be used to update a television program guide.

Furthermore, in one embodiment of the present disclosure, when any void television channel failing to correspond to the channel-selection signal exists in the current channel data, the channel-switching routine can respond to an error message and then switch back to a previous television channel before receiving the channel-selection signal.

According to the above-described embodiments, the method for scanning television channels is generally adapted to a television apparatus. The television apparatus refers to electronic devices that are able to play instant streaming data of selectable channels. The method is primarily directed against the problems of void channels formed because the television channels are scanned incompletely. After analyzing the channel data stored in the television apparatus, a background scanning routine is performed only on the void channels, but does not rescan all the television channel data. If the channel data of the void channel is obtained, the channel data of the void channel can be used to update the channel data and the television program guide in the television apparatus. The channel-switching routine switches to the channel selected by the user when the scanning result is received. Even though the scanning process is in operation, the user may not feel any delay or only feel very low delay when watching the television program.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for scanning television channels, which is adapted to a television apparatus, the method comprising:
receiving a channel-selection signal that corresponds to a television channel;
analyzing channel data stored in the television apparatus, so as to determine whether or not the channel data includes the television channel; and
performing a scanning routine in a background if the channel data does not include the television channel corresponding to the channel-selection signal to scan the television channel failing to correspond to the channel-selection signal and generate a scanning result; then, updating the channel data stored in the television apparatus.

2. The method according to claim 1, wherein the channel data stored in the television apparatus is produced by steps of:
performing the scanning routine in the television apparatus, so as to obtain the channel data including one or more television channel data; and
storing the channel data to a storage device of the television apparatus.

3. The method according to claim 1, wherein the channel-selection signal is generated by a remote control manipulated by a user.

4. The method according to claim 1, wherein a channel-switching routine performed in the television apparatus receives the scanning result generated by the scanning routine, and the television apparatus switches to the television channel corresponding to the channel-selection signal.

5. The method according to claim 4, wherein, when the channel data is determined to not include the television channel corresponding to the channel-selection signal, the channel-switching routine responds with an error message, and a previous television channel, before receiving the channel-selection signal, is switched back on by the television apparatus.

6. The method according to claim 5, wherein the channel data stored in the television apparatus is produced by steps of:
performing the scanning routine in the television apparatus so as to retrieve the channel data including one or more television channel data; and
storing the channel data to a storage device of the television apparatus.

7. The method according to claim 1, wherein, when the scanning routine executed in the background generates the scanning result, the channel data stored in the television apparatus is updated, and a television program guide of the channel data is updated.

8. The method according to claim 7, wherein the channel data stored in the television apparatus is produced by steps of:
performing the scanning routine in the television apparatus so as to obtain the channel data covering one or more television channel data; and
storing the channel data to a storage device of the television apparatus.

9. A television system, comprising:
a circuit system used to receive television streaming data, demodulate the television streaming data, separate information in the television streaming data, and decompress and convert the television streaming data to video and audio;
a storage unit having a channel database; and
a control circuit electrically connected to circuit elements of the circuit system, wherein a method for scanning television channels includes:
receiving, by a channel-selection transceiver circuit, a channel-selection signal that corresponds to a television channel;
analyzing channel data stored in the storage unit, so as to determine whether or not the channel data includes the television channel; and
performing a scanning routine in a background if the channel data does not include the television channel corresponding to the channel-selection signal to scan the television channel failing to correspond to the channel-selection signal and generate a scanning result; then, updating the channel data stored in the storage unit.

10. The television system according to claim 9, wherein the channel data is produced by steps of:
performing the scanning routine, so as to retrieve the channel data covering one or more television channel data; and
storing the channel data to the storage unit.

11. The television system according to claim 10, wherein the channel data covering the one or more television channel data is obtained from a content server, and the channel data is used to form a television program guide.

12. The television system according to claim 9, wherein the circuit system includes:
a tuning circuit used to receive the television streaming data;
a demodulation circuit used to demodulate the television streaming data;
a demultiplexing circuit for demultiplexing and separating the information in the television streaming data; and
a decoding circuit for decompressing the television streaming data and converting the television streaming data to video and audio.

13. The television system according to claim 9, wherein the channel-selection signal is generated by a remote control manipulated by a user, and the channel-selection signal is received by the channel-selection transceiver circuit.

14. The television system according to claim 13, wherein the channel data is produced by steps of:
performing the scanning routine, so as to retrieve the channel data covering one or more television channel data; and
storing the channel data to the storage unit.

15. The television system according to claim 14, wherein a channel-switching routine receives the scanning result generated by the scanning routine, and the television channel corresponding to the channel-selection signal is switched on.

16. The television system according to claim 15, wherein, when the channel data is determined to not include the television channel corresponding to the channel-selection signal, the channel-switching routine responds with an error message, and a previous television channel, before receiving the channel-selection signal, is switched back on.

17. The television system according to claim 9, wherein, when the scanning routine executed in the background generates the scanning result, the channel data stored in the storage unit is updated, and a television program guide of the channel data is updated.

18. The television system according to claim 17, wherein the channel data is produced by steps of:
performing the scanning routine, so as to retrieve the channel data covering one or more television channel data; and
storing the channel data to the storage unit.

19. The television system according to claim 18, wherein the channel data covering the one or more television channel data is obtained from a content server.

20. The television system according to claim 19, wherein the channel data forms a television program guide.
